(19) United States
(12) Patent Application Publication
(10) Pub. No.: US 2026/0095871 A1
(43) Pub. Date: Apr. 2, 2026

(54) SYSTEM AND METHOD FOR SELECTING TRANSMITTER POWER

(71) Applicant: Samsung Electronics Co., Ltd., Suwon-si (KR)

(72) Inventors: Rohan POTE, San Diego, CA (US); Hyukjoon KWON, San Diego, CA (US); Dongwoon BAI, San Diego, CA (US)

(21) Appl. No.: 19/329,416

(22) Filed: Sep. 15, 2025

Related U.S. Application Data
(60) Provisional application No. 63/700,483, filed on Sep. 27, 2024.

(51) Int. Cl. H04W 52/22; H04W 52/24

(52) U.S. Cl. CPC H04W 52/228; H04W 52/243

(57) ABSTRACT

A system and method for selecting transmitter power. In some embodiments, a method includes: determining, by a first transceiver, a power indicator for a second transceiver; and sending, by the first transceiver, the power indicator to the second transceiver, the determining including executing a second operation of a power-setting procedure, the power-setting procedure including a first operation and the second operation, the executing of the second operation including: determining that an updated parameter vector, differing from a previous parameter vector by a first step vector, includes a first element and a second element differing by less than a threshold; and based on determining that the updated parameter vector includes a first element and a second element differing by less than the threshold, adding a second step vector to the previous parameter vector, the second step vector having a magnitude less than a magnitude of the first step vector.

### CROSS-REFERENCE TO RELATED APPLICATION

This application claims the priority benefit under 35 U.S.C. § 119 (e) of U.S. Provisional Application No. 63/700,483, filed on Sep. 27, 2024, the disclosure of which is incorporated by reference in its entirety as if fully set forth herein.

### TECHNICAL FIELD

The disclosure generally relates to wireless communications. More particularly, the subject matter disclosed herein relates to improvements to systems and methods for selecting transmitter power.

### SUMMARY

Wireless communications systems are used in a broad variety of applications. In some wireless systems a first transceiver may communicate with a plurality of other transceivers. The other transceivers, if transmitting simultaneously, may interfere with each other.

To solve this problem the first transceiver may send a power indicator to each of the other transceivers, which may indicate the transmitter power to be used by the other transceiver (e.g., for each antenna of the other transceiver). The power levels may be selected (i) such that each of the other transceivers is able to meet a respective target uplink data rate, while (ii) consuming as little power as possible.

One issue with the above approach is that optimization methods for finding a suitable power indicator for each transmitter may converge too slowly to be used without unacceptable performance degradation.

To overcome these issues, systems and methods are described herein for finding power indicators, using a method that converges rapidly.

The above approaches improve on previous methods because the convergence time may be significantly reduced.

According to an embodiment of the present disclosure, there is provided a method, including: determining, by a first transceiver, a power indicator for a second transceiver; and sending, by the first transceiver, the power indicator to the second transceiver, the determining including executing a second operation of a power-setting procedure, the power-setting procedure including a first operation and the second operation, the executing of the second operation including: determining that an updated parameter vector, differing from a previous parameter vector by a first step vector, includes a first element and a second element differing by less than a threshold; and based on determining that the updated parameter vector includes a first element and a second element differing by less than the threshold, adding a second step vector to the previous parameter vector, the second step vector having a magnitude less than a magnitude of the first step vector.

In some embodiments: the second step vector is calculated based on an ellipsoid parameter, and the method further includes updating the ellipsoid parameter based on determining that the updated parameter vector includes a first element and a second element differing by less than the threshold.

In some embodiments, the adding of the second step vector to the previous parameter vector is further based on determining that: in the previous parameter vector the first element is greater than the second element, and in the updated parameter vector the first element is less than the second element.

In some embodiments: the adding of the second step vector to the previous parameter vector is further based on determining that a first cluster of elements, within the previous parameter vector, includes the same elements as a corresponding cluster of elements in the updated parameter vector; and each of the first cluster of elements and the corresponding cluster of elements in the updated parameter vector includes a plurality of values separated by less than a threshold.

In some embodiments, the threshold is less than 0.01 times a value of an element of the first cluster of elements.

In some embodiments: the adding of the second step vector to the previous parameter vector is further based on determining that each cluster of elements, within the previous parameter vector, includes the same elements as a respective corresponding cluster of elements in the updated parameter vector; each cluster of elements includes a plurality of values separated by less than a threshold; and each respective corresponding cluster of elements includes a plurality of values separated by less than a threshold.

In some embodiments, the method further includes calculating the second step vector, the calculating including calculating a scale factor, and calculating the second step vector based on the scale factor.

In some embodiments, the method further includes: calculating a third step vector, the calculating including calculating a scale factor; determining that the scale factor is less than a threshold; and based on determining that the scale factor is less than the threshold, determining that convergence has occurred.

In some embodiments, the threshold is less than 0.0001.

According to an embodiment of the present disclosure, there is provided a system including: a wireless transceiver, including one or more processors; and a memory storing instructions which, when executed by the one or more processors, cause performance of: determining a power indicator for a second transceiver; and sending the power indicator to the second transceiver, the determining including executing a second operation of a power-setting procedure, the power-setting procedure including a first operation and the second operation, the executing of the second operation including: determining that an updated parameter vector, differing from a previous parameter vector by a first step vector, includes a first element and a second element differing by less than a threshold; and based on determining that the updated parameter vector includes a first element and a second element differing by less than the threshold, adding a second step vector to the previous parameter vector, the second step vector having a magnitude less than a magnitude of the first step vector.

In some embodiments: the second step vector is calculated based on an ellipsoid parameter, and the instructions, when executed by the one or more processors, further cause performance of: updating the ellipsoid parameter based on determining that the updated parameter vector includes a first element and a second element differing by less than the threshold.

In some embodiments, the adding of the second step vector to the previous parameter vector is further based on determining that: in the previous parameter vector the first element is greater than the second element, and in the updated parameter vector the first element is less than the second element.

In some embodiments: the adding of the second step vector to the previous parameter vector is further based on determining that a first cluster of elements, within the previous parameter vector, includes the same elements as a corresponding cluster of elements in the updated parameter vector; and each of the first cluster of elements and the corresponding cluster of elements in the updated parameter vector includes a plurality of values separated by less than a threshold.

In some embodiments, the threshold is less than 0.01 times a value of an element of the first cluster of elements.

In some embodiments: the adding of the second step vector to the previous parameter vector is further based on determining that each cluster of elements, within the previous parameter vector, includes the same elements as a respective corresponding cluster of elements in the updated parameter vector; each cluster of elements includes a plurality of values separated by less than a threshold; and each respective corresponding cluster of elements includes a plurality of values separated by less than a threshold.

In some embodiments, the instructions, when executed by the one or more processors, further cause performance of: calculating the second step vector, the calculating including calculating a scale factor, and calculating the second step vector based on the scale factor.

In some embodiments, the instructions, when executed by the one or more processors, further cause performance of: calculating a third step vector, the calculating including calculating a scale factor; determining that the scale factor is less than a threshold; and based on determining that the scale factor is less than the threshold, determining that convergence has occurred.

In some embodiments, the threshold is less than 0.0001.

According to an embodiment of the present disclosure, there is provided a system including: means for processing; and a memory storing instructions which, when executed by the means for processing, cause performance of: determining a power indicator for a second transceiver; and sending the power indicator to the second transceiver, the determining including executing a second operation of a power-setting procedure, the power-setting procedure including a first operation and the second operation, the executing of the second operation including: determining that an updated parameter vector, differing from a previous parameter vector by a first step vector, includes a first element and a second element differing by less than a threshold; and based on determining that the updated parameter vector includes a first element and a second element differing by less than the threshold, adding a second step vector to the previous parameter vector, the second step vector having a magnitude less than a magnitude of the first step vector.

In some embodiments: the second step vector is calculated based on an ellipsoid parameter, and the instructions, when executed by the means for processing, further cause performance of: updating the ellipsoid parameter based on determining that the updated parameter vector includes a first element and a second element differing by less than the threshold.

### BRIEF DESCRIPTION OF THE DRAWINGS

In the following section, the aspects of the subject matter disclosed herein will be described with reference to exemplary embodiments illustrated in the figures, in which:

FIG. 1A is a system level block diagram of a system for wireless communications, according to an embodiment.

FIG. 1B is a block diagram of a transceiver, according to an embodiment.

FIG. 2 is a flow chart illustrating aspects of a method for finding a power indicator, according to an embodiment.

FIG. 3 is a diagram of ellipsoids that may be used to find a power indicator, according to an embodiment.

FIG. 4 is a pseudocode listing of a portion of a method for finding a power indicator, according to an embodiment.

FIG. 5 is an illustration of a set of clusters, according to an embodiment.

FIG. 6A is a flow chart of a first portion of a method for selecting a transmitter power, according to an embodiment.

FIG. 6B is a flow chart of a second portion of a method for selecting a transmitter power, according to an embodiment.

FIG. 7 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, each of the terms “processing circuit” and “means for processing” refers to any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

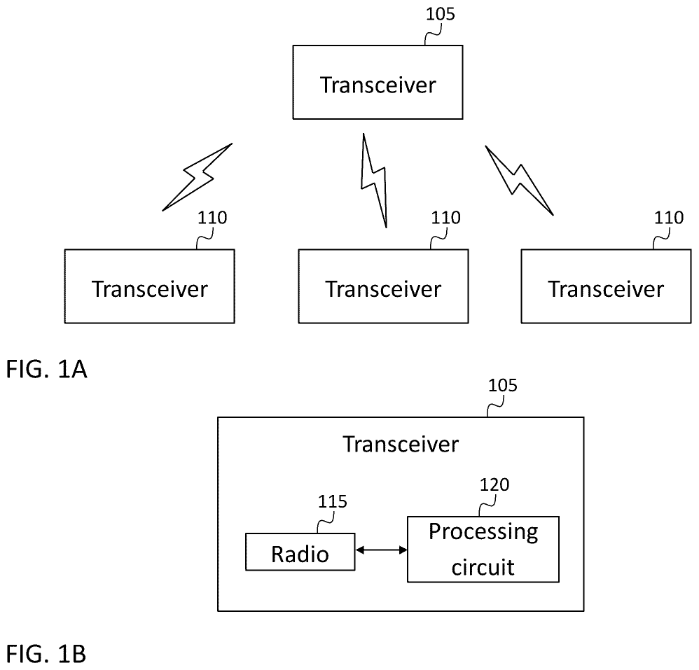

FIG. 1A depicts a system with a plurality of transceivers (e.g., an access-point station 105 and non-access point stations 110 in a wireless network), in communication with each other. In the embodiment of FIG. 1A, a first transceiver (which may be referred to as an access point station (AP STA) 105) conducts point-to-point communications with the remainder of the transceivers, which may be referred to as non-access-point stations 110 (non-AP STAs). The access point station 105 and the non-access-point stations 110 may be part of a Wi-Fi network (e.g., a wireless network complying with standard IEEE 802.11, promulgated by the Institute of Electrical and Electronics Engineers (IEEE)). The communications may be point-to-point in the sense that each packet or frame of data may be transmitted for the purpose of being received by only one of the transceivers 105, 110, even though each such packet or frame may be transmitted, by one of the transceivers 105, 110 via free-space electromagnetic waves which may reach all of the other transceivers 105, 110. Each transceiver (e.g., the access point station 105, as shown in FIG. 1B) may include a radio 115 and a processing circuit 120 (e.g., a microprocessor or a microcontroller).

Some communications within the wireless network may be broadcast transmissions. For example, the access point station 105 may periodically transmit informational frames, which may be referred to as beacon frames, for the purpose of allowing other transceivers, which have not yet interacted with the wireless network, to obtain information that such transceivers may use to join the wireless network.

In operation, data may be exchanged between the access point station 105 and each of the non-access-point stations 110. For example, the access point station 105 may, during a period of operation, send one or more frames to each of the non-access-point stations 110 and the access point station 105 may receive, from each of the non-access-point stations 110, one or more frames.

To coordinate the reception of frames by the access point station 105 from the non-access-point stations 110, the access point station 105 may control the non-access-point stations 110 to transmit in such a way as to avoid interference between the respective transmissions of the non-access-point stations 110 or in such a way that the interference between the respective transmissions of the non-access-point stations 110 is sufficiently small that each of the non-access-point stations 110 is capable of transmitting frames to the access point station 105. For example, the access point station 105 may send control information to each of the non-access-point stations 110, informing each of the non-access-point stations 110 of resources allocated to it for transmitting data to the access point station 105. The resources may be allocated in units of resource elements, each of which may correspond to a subcarrier (in an orthogonal frequency-division multiplexing system) and a time interval (which may be referred to as a symbol interval). In such an embodiment, the access point station 105 may allocate resources so that each resource element is used by only one of the non-access-point stations 110. Such a mode of operation may be referred to as orthogonal multiple access (OMA).

The use of orthogonal multiple access may, however, result in non-optimal data rates. For example, it may be possible for two non-access-point stations 110 to achieve a greater aggregate uplink data rate if the two non-access-point stations 110 transmit during the same resource elements than if each of the two non-access-point stations 110 transmits only during a respective set of resource elements allocated exclusively to the non-access-point station 110. As used herein an “uplink” transmission and an “uplink” data rate refer respectively to a transmission from a non-access-point stations 110 to the access point station 105, and to a data rate achieved for transmissions from a non-access-point station 110 to the access point station 105. Non-access-point stations 110 that transmit data within the same resource element may be referred to as “concurrently transmitting non-access-point stations” 110, or as “users”.

The ability of the access point station 105 to receive data within a single resource element from two or more non-access-point stations 110 may be enabled in part by the use of successive interference cancellation (SIC). When successive interference cancellation is used by the access point station 105, the access point station 105 may decode transmissions made by each of the two or more non-access-point stations 110 in an order referred to as a decoding order.

The decoding may include forward error correction, allowing the access point station 105 to infer what data was transmitted by the first non-access-point station 110 in the decoding order, even if interference (e.g., from other non-access-point stations 110) or noise would have prevented error-free reception absent the use of forward error correction encoding. After decoding the transmission received from the first non-access-point station 110 in the decoding order, the access point station 105 may infer from the decoded transmission what signal was transmitted by the first non-access-point station 110 in the decoding order, (e.g., the subcarriers that were transmitted, and the modulation symbols that were transmitted on each subcarrier) and subtract this signal from the raw received signal (which (i) may include the contributions of all of the non-access-point stations 110 that contributed to the received signal, and which (ii) may have been stored, by the access point station 105, for the purpose of performing such subtractions), to generate a modified signal, which may be referred to as the remaining raw received signal, and which may be approximately equal to the sum of the contributions from the non-access-point stations 110 except the first non-access-point stations 110 in the decoding order. The access point station 105 may repeat the process of subtracting the contribution to the raw received signal of a non-access-point station 110, for each non-access-point station 110 except the last non-access-point station 110 in the decoding order. In this manner, each of the transmissions from the concurrently transmitting non-access-point stations 110 may be decoded.

In such a system, the access point station 105 may control the power transmitted by each of the non-access-point stations 110 by instructing the non-access-point stations 110 accordingly. It may be advantageous to conserve power in the non-access-point stations 110, especially if the non-access-point stations 110 are battery-powered. The signal-to-interference ratio of the signals received by the access point station 105 may be unaffected by the transmitted power if the only source of interference is concurrently transmitting non-access-point stations 110 and if noise is negligible, but in the presence of noise or interference from other sources, the uplink data rate achievable by any one of the non-access-point stations 110 may increase if the transmitted power of the non-access-point station 110 is increased.

Because such an increase in uplink data rate resulting from such an increase in power may be achieved at the expense of the uplink data rate of another concurrently transmitting non-access-point station 110, however, the access point station 105 may specify for each of the concurrently transmitting non-access-point stations 110 to transmit at a power level that, in the presence of transmissions from each of the other concurrently transmitting non-access-point stations 110 at the respective specified power level, allows the non-access-point station 110 to achieve a respective target uplink data rate to the access point station 105. The access point station 105 may further specify a set of power levels that minimizes some aggregate measure of the total power consumption of the concurrently transmitting non-access-point stations 110 (e.g., so as to maximize battery life). The power level specified by the access point station 105 to each of the concurrently transmitting non-access-point stations 110 may be referred to as a “power indicator”. The power indicator may be a covariance matrix (discussed in further detail below). The received signal, yₙ∈ [symbol] ^{Ly}, in the n-th SC of such a resulting frequency flat channel is given by

$${y}_{n} = {\sum }_{u = o}^{U} {H}_{u , n} {x}_{u , n} + {z}_{n} , \qquad ( 1 )$$

where H_{u,n}∈ [symbol] ^{Ly}×L_{x,u} and x_{u,n} denote the uplink channel and the transmit symbols for the user u in SC index n. zₙ is the additive Gaussian noise with covariance R_{zz}(n).

This optimization problem may be expressed as follows:

$${{arg min}_{{R}_{xx} ( u , n ) ≽ 0 ,}}_{u ∈ [ U ] , n ∈ [ N ]} {\sum }_{u = 0}^{U - 1} {w}_{u} ( {\sum }_{n = o}^{N - 1} trace ( {R}_{xx} ( u , n ) ) ) \qquad ( 1 )$$

$$s . t . r ( n ) ∈ 𝒞 ( \{ {R}_{xx} ( u , n ) \vert u ∈ U \} ) , n ∈ [ N ]$$

$${\sum }_{n = 0}^{N - 1} r ( u , n ) \geq {r}_{min , u} , u ∈ [ U ]$$

where Rₓₓ(u, n) denotes the input covariance matrix for the transmit symbols by user u at SC n, wᵤ, u∈[U] denotes the weight for power of user u, r_{min,u} denotes the target rate for user u and

$$𝒞 ( \{ {R}_{xx} ( u , n ) \vert u ∈ U \} ) = \{ r \vert {\sum }_{u ∈ 𝕊} {r}_{u} \leq log det ( {R}_{zz} ( n ) + {\sum }_{u ∈ 𝕊} {H}_{u , n} {R}_{xx} ( u , n ) {H}_{u , n}^{H} ) - log det {R}_{zz} ( n ) , \text{} ∀ 𝕊 ⊆ [ U ] \}$$

denotes the polytope of capacity region conditioned on the user covariance matrices for the n-th subcarrier. r(n)=[r(0, n) r(1, n) . . . r(U−1, n)]^{T} denotes the vector of achievable user rates. N is the number of subchannels (SCs) and U is the number of concurrently transmitting non-access-point stations 110, or “users”. R_{zz}(n) is the covariance matrix of the noise in the n^{th} channel.

The covariance matrix Rₓₓ(u, n) of the concurrently transmitting non-access-point station 110 u is the covariance of the signals transmitted by the antennas of the concurrently transmitting non-access-point station 110 u. As such, the total power transmitted by the concurrently transmitting non-access-point station 110 u is given by

$${\sum }_{n = o}^{N - 1} trace ( {R}_{xx} ( u , n ) ) ,$$

and, in the above statement of the optimization problem (Equation 1), a set of covariance matrices Rₓₓ(u, n) is sought that minimizes a weighted sum, over all of the concurrently transmitting non-access-point stations 110 u, of the total power transmitted by each of the concurrently transmitting non-access-point stations 110. This weighted sum is given by the term

$${\sum }_{u = 0}^{U - 1} {w}_{u} ( {\sum }_{n = o}^{N - 1} trace ( {R}_{xx} ( u , n ) ) )$$

The optimization is performed subject to the constraints that each of the concurrently transmitting non-access-point stations 110 meets its respective target uplink data rate. This constraint is captured in the requirements that:

$${\sum }_{n = 0}^{N - 1} r ( u , n ) \geq {r}_{min , u} , u ∈ [ U ]$$

with, as mentioned above, r(u, n) being within the respective capacity polytope for the respective concurrently transmitting non-access-point stations 110 and for the respective subcarrier, the capacity polytope being a function of Rₓₓ(u, n) (e.g., of the power transmitted by the concurrently transmitting non-access-point stations 110 in the respective subcarrier), as shown above.

The constrained optimization problem of Equation 1 above may be transformed, using the method of Lagrange multipliers, into an unconstrained optimization problem, expressed as follows:

$${max}_{θ \geq 0} {min}_{{R}_{x x} ( u , n ) , u ∈ [ U ] , n ∈ [ N ]} L ( θ , \{ {R}_{x x} ( u , n ) \} ) .$$

where θ∈ [symbol] ^{U} denotes the vector of Lagrange multipliers, and

$$\begin{matrix}L ( θ , \{ {R}_{xx} ( u , n ) \} = {\sum }_{u = 0}^{U - 1} {w}_{u} {\sum }_{n = 0}^{N - 1} trace ( {R}_{xx} ( u , n ) ) + {θ}_{{π}_{θ} ( U - 1 )} log det {R}_{zz} n \\ - {\sum }_{v = 0}^{U - 2} ( {θ}_{{π}_{θ} ( v + 1 )} \\ - {θ}_{{π}_{θ} ( v )} ) ( {\sum }_{n = 0}^{N - 1} {b}_{{π}_{θ} ( v + 1 ) , n} - {b}_{min , {π}_{θ} ( v + 1 )} \\ - {θ}_{{π}_{θ} ( 0 )} ( {\sum }_{n = 0}^{N - 1} {b}_{{π}_{θ} ( 0 ) , n} - {b}_{min , {π}_{θ} ( 0 )} ) ,\end{matrix}$$

$${b}_{u , n} = log det ( {R}_{zz} ( n ) + {\sum }_{v = {π}_{θ}^{- 1} ( u )}^{U - 1} {H}_{{π}_{θ} ( v ) , n} {R}_{xx} ( {π}_{θ} ( v ) , n ) {H}_{{π}_{θ} ( v ) , n}^{H} ) , and$$

$${b}_{min , u} = {\sum }_{v = {π}_{θ}^{- 1} ( u )}^{U - 1} {r}_{min , {π}_{θ} ( v )}$$

This unconstrained optimization problem may be referred to as the “Lagrangian dual” problem. The Lagrangian dual problem may be solved, approximately, using alternating numerical optimizations, which may be used to alternately find (i) the minimum of L(θ,{Rₓₓ(u, n)}), over Rₓₓ(u, n), for fixed θ, and (ii) the maximum L(θ,{Rₓₓ(u, n)}), over θ, for fixed Rₓₓ(u, n), until convergence is detected. θ is a vector of elements that may be referred to as “rate rewards” which are the Lagrangian multipliers used in the Lagrangian dual problem. The vector θ includes one element for each of the concurrently transmitting non-access-point stations 110. These elements may be present in arbitrary order in the vector θ. The decoding order used by the access point station 105 may be obtained by sorting the elements of θ by size, with the largest element of θ being decoded first. The decoding order may be related to the ordering of the elements of θ by a permutation π.

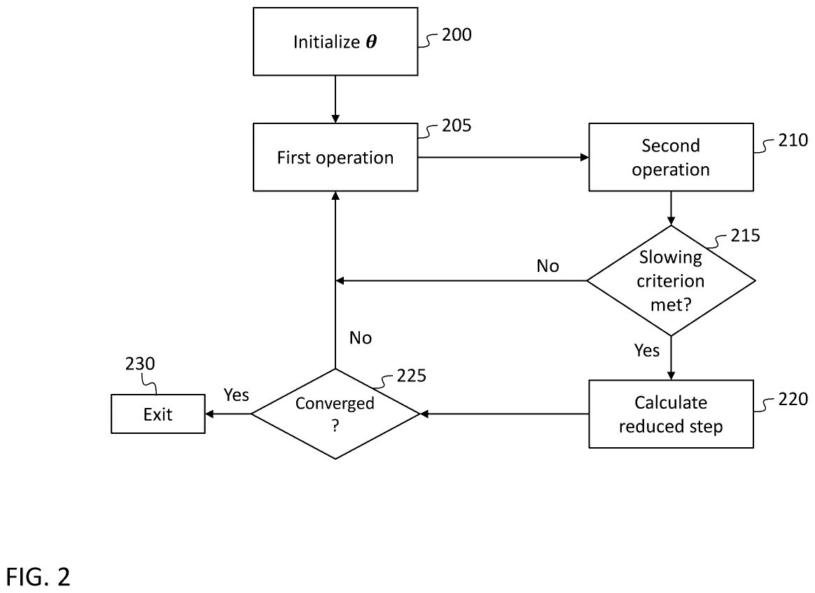

Further details of a method for finding a power indicator are illustrated in FIG. 2. Although FIG. 2 illustrates various operations in a method for finding a power indicator according to some embodiments, embodiments according to the present disclosure are not limited thereto, and according to various embodiments, the method may include additional operations, or fewer operations, or the order of operations may vary, unless otherwise stated or implied, without departing from the spirit and scope of embodiments according to the present disclosure.

After initializing θ at 200, a first numerical optimization, and a second numerical optimization are performed alternately, the first numerical optimization being performed at 205, and the second numerical optimization being performed at 210. The first numerical optimization, performed at 205, numerically finds the (approximate) minimum of L(θ,{Rₓₓ(u, n)}), over Rₓₓ(u, n), for fixed θ, which is initially set using a Simultaneous Water Filling (SWF) algorithm (which may be an algorithm for power allocation to multiple transmitters in a wireless communications system).

The second numerical optimization, which is performed at 210, may use, for the fixed value of Rₓₓ(u, n) the value found by the first iteration of the first numerical optimization, which is performed at 205. On subsequent iterations, if, at 215, a slowing criterion (discussed in further detail below) is not met, the first numerical optimization, which is performed at 205, uses for θ the value generated by the most recent iteration of the second numerical optimization, which is performed at 210.

The second numerical optimization, which is performed at 210, may be performed using an ellipsoid algorithm. In the ellipsoid algorithm, a U—dimensional ellipsoid may be defined such that it includes θ. At each iteration, the value of θ may be adjusted, and the current ellipsoid may be replaced by a new, smaller ellipsoid, until, at some iteration, the volume of the ellipsoid is sufficiently small that convergence has occurred (e.g., sufficiently small that the amount by which θ can vary, within the volume of the final ellipsoid, is sufficiently small to avoid a significant waste of transmitted power). The smaller ellipsoid may be one that includes a portion of the current ellipsoid, determined by the subgradient, when the current ellipsoid is cut into two pieces at a cutting plane (discussed in further detail below).

At each iteration of the second numerical optimization, which is performed at 210, the adjusting of θ and of the ellipsoid may be performed as follows, based on the subgradient of h(θ), with respect to θ, where h(θ) is defined as

$$h ( θ ) = {min}_{{R}_{xx} ( u , n ) , u ∈ [ U ] , n ∈ [ N ]} L ( θ , \{ {R}_{xx} ( u , n ) \} ) .$$

A modified subgradient g^{(k-1)} may be calculated as:

$${\tilde{g}}^{( k - 1 )} = \frac{1}{\sqrt{{g}^{{( k - 1 )}^{H}} {A}^{( k - 1 )} {g}^{( k - 1 )}}} {g}^{( k - 1 )}$$

where g^{(k-1)}, given by

$${g}^{( k - 1 )} = - ( {\sum }_{n = 0}^{N - 1} {r}^{( k - 1 )} ( n ) - {r}_{min} ) ,$$

is the subgradient of h(θ) with respect to θ, and k is the iteration index.

A new value of θ may then be calculated using:

$${θ}^{k} = {θ}^{( k - 1 )} + \frac{1}{U + 1} {A}^{( k - 1 )} {\tilde{g}}^{( k - 1 )}$$

Where A^{(k-1)} is the matrix defining the shape and size of the ellipsoid (e.g., A) is a matrix the eigenvectors of which are parallel to the principal axes of the ellipsoid, and each eigenvalue of which is the size the ellipsoid in the direction of the corresponding eigenvector). This matrix may be referred to as the “ellipsoid parameter”. The quantity

$$\frac{1}{U + 1} {A}^{( k - 1 )} {\tilde{g}}^{( k - 1 )}$$

is a vector (i) which determines the amount by which θ is adjusted and (ii) which may be referred to as the “ordinary step vector”.

A new value of A may then be calculated using the following expression:

$${A}^{k} = \frac{{U}^{2}}{{U}^{2} - 1} ( {A}^{( k - 1 )} - \frac{2}{U - 1} \times {A}^{( k - 1 )} {{\tilde{g}}^{( k - 1 )} ( {\tilde{g}}^{( k - 1 )} )}^{H} {( {A}^{( k - 1 )} )}^{H} ) )$$

This result may be stored for the next iteration of the second numerical optimization, which is performed at 210. The above expression may be referred to as the ordinary updating expression for the ellipsoid parameter A.

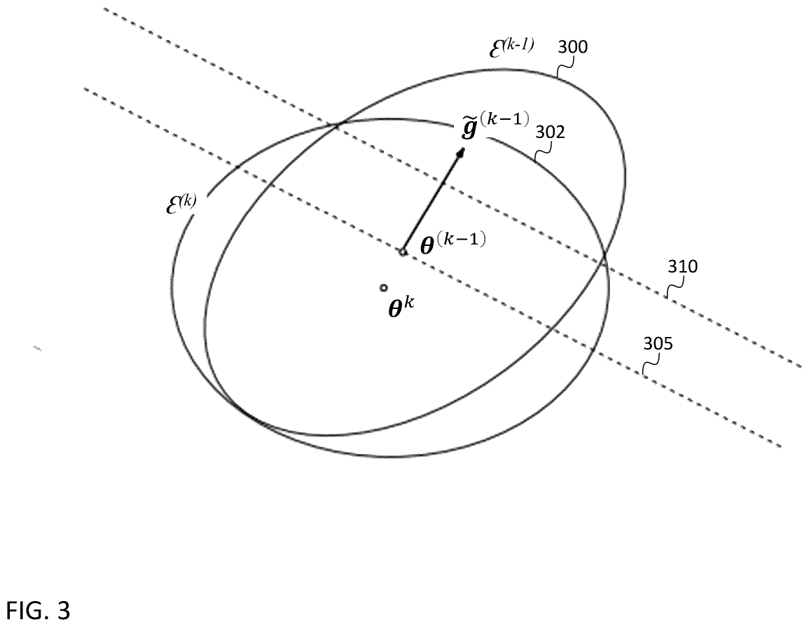

The new ellipsoid ε^{(k)} may have a size and shape corresponding to this new matrix A^{k} and a centroid at ok. One iteration of this process is illustrated in FIG. 3, which shows the ellipsoid 300 (ε^{(k-1)}) defined by the matrix A^{(k-1)} and the centroid θ^{(k-1)}, the cutting plane 305, which is perpendicular to the vector \tilde{g}^{(k-1)}, and the new ellipsoid 302 (ε^{(k)}) defined by the matrix A^{k} and the centroid θ^{k}. Instead of cutting at 305, as in some algorithms, a “shallow” cut may be made at 310. FIG. 3 shows a shallow-cut ellipsoid method, in the sense that the step size, and the reduction in size of the ellipsoid with one iteration, as a fraction of the size of the ellipsoid, is relatively modest. Other ellipsoid methods may use a standard cut, or deep cut, which may result in a more rapid reduction in the size of the ellipsoid, but which may be subject to some of the convergence issues discussed herein. The shallow cut, and, for example, a step size that avoids a change in decoding order within any cluster may, as discussed below, mitigate such convergence issues.

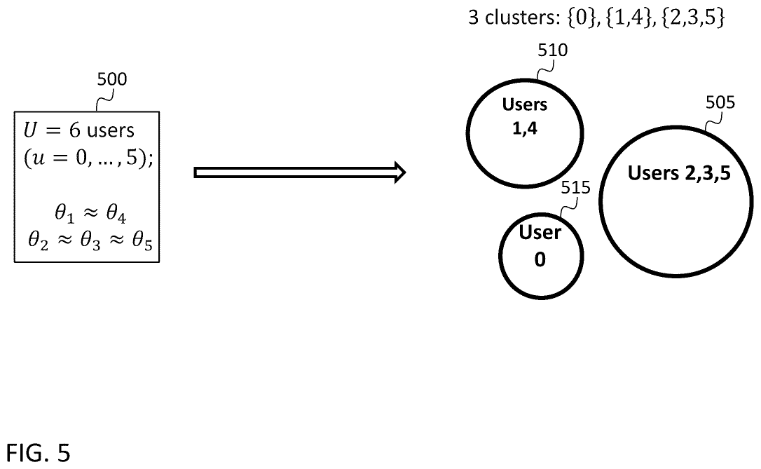

If, at 215, the slowing criterion is met, a different set of operations is performed, as illustrated in FIG. 2. The testing of the slowing criterion, and the operations performed if it is met, may allow the method to converge more rapidly, as discussed in further detail below. It may be that among the elements of θ (each or which corresponds to a respective one of the concurrently transmitting non-access-point stations 110) two or more are identical or nearly identical, initially, or after any iteration of the second numerical optimization, which is performed at 210. Any two or more elements of θ that are identical or nearly identical e.g., that differ by less than a first threshold, may be referred to as a “cluster”. The first threshold may be between 0.01 and 0.0001 (e.g., 0.001) times the value of an element already in the cluster, or times the value of either of two elements being considered for the forming of a new cluster. FIG. 5 shows the clusters present in an example in which the elements 500 of θ include three elements (elements 2, 3, and 5) that are equal or nearly equal, forming a first cluster 505, two additional elements (elements 1 and 4) that are equal or nearly equal, forming a second cluster 510, and one element, element 0, which is not equal to nor nearly equal to any other element, forming a third cluster 515. The presence of clusters may slow convergence of the optimization if the ordinary updating expression for the ellipsoid parameter A and the ordinary step vector are used, because the addition to θ of the ordinary step vector may result in a change of the decoding order within a cluster, causing the new value of theta to correspond to a different vertex of the capacity polytope. This change from one vertex to another may be referred to as “vertex hopping”. This may also cause a change in sign (“sign flipping”) of one or more elements of the gradient of h(θ).

Without loss of generality it may be assumed that theta is ordered as follows: θ₀≤θ₁≤θ₂≤ . . . ≤θ_{U-1}, and this assumption is used for the remainder of this disclosure. As such, to prevent a change of the decoding order within any cluster, the method may add, to 0, a step vector that is smaller than the ordinary step vector, when the slowing criterion is met. For example, referring to FIG. 2, if, at 215, it is determined that the slowing criterion is met, then at 220, a scale factor β (which is greater than or equal to zero and less than 1) is calculated as:

$$β = {min}_{m ∈ [ U \} \backslash \{ {\overline{G}}_{i} \vert i ϵ [ {U}^{( k - 1 )} ] \}} max \{ {β}_{m} , 0 ) \}$$

where G̅ᵢ is the number of concurrently transmitting non-access-point stations 110 in the decoding order before the i^{th} cluster, and

$${β}_{m} = - ( U + 1 ) \frac{{θ}_{m}^{( k - 1 )} - {θ}_{m - 1}^{( k - 1 )}}{( {A}_{m , :}^{( k - 1 )} - {A}_{m - 1 , :}^{( k - 1 )} ) {\tilde{g}}^{( k - 1 )}} ,$$

where a colon (“:”) means all column entries in the m-th or m−1th row.

If the scale factor β is less than a second threshold, then, at 225 the optimization is deemed to have converged, the method exits at 230, and the values of Rₓₓ calculated in the last iteration of the first numerical optimization, which is performed at 205, is transmitted to the concurrently transmitting non-access-point stations 110 as the set of covariance matrices to be used during transmission. The second threshold may be between 0.001 and 1e−6, e.g., it may be about 0.00001 (i.e., 1e−5).

A reduced step vector, equal to

$$β \frac{1}{U + 1} {A}^{( k - 1 )} {\tilde{g}}^{( k - 1 )}$$

may also be calculated (e.g., before or after step 225), and a new updated θ may be calculated, using the reduced step vector instead of the ordinary step vector, e.g.,

$${θ}^{( k )} = {θ}^{( k - 1 )} + β \frac{1}{U + 1} {A}^{( k - 1 )} {\tilde{g}}^{( k - 1 )}$$

The use of the reduced step vector may avoid the reordering of elements within a cluster (i.e., a change in the decoding order of the elements within a cluster) that may occur if the ordinary step vector is used. As such, the use of the reduced step vector may avoid the sign flipping, vertex hopping, and slow convergence that may occur if the ordinary step vector is used when the slowing criterion is met. When the slowing criterion is met, the ellipsoid parameter may also be updated by a different equation than is used with the ordinary step vector; it may be updated using the following expression:

$${A}^{( k )} = \frac{{U}^{2}}{{U}^{2} - 1} ( 1 - {α}^{2} ) ( {A}^{( k - 1 )} - \frac{2}{U + 1} \times \frac{1 + U α}{1 + α} {A}^{( k - 1 )} {{\tilde{g}}^{( k - 1 )} ( {\tilde{g}}^{( k - 1 )} )}^{H} {( {A}^{( k - 1 )} )}^{H} )$$

where

$$α = \frac{β - 1}{U} < 0.$$

The above expression may be referred to as the reduced updating expression for the ellipsoid parameter A.

If, at 225, it is determined that the scale factor β is not less than the second threshold, then the updated value θ^{k} (which has been changed from the previous value by only the reduced step vector) is used for the next iteration of the first numerical optimization, which is performed at 205.

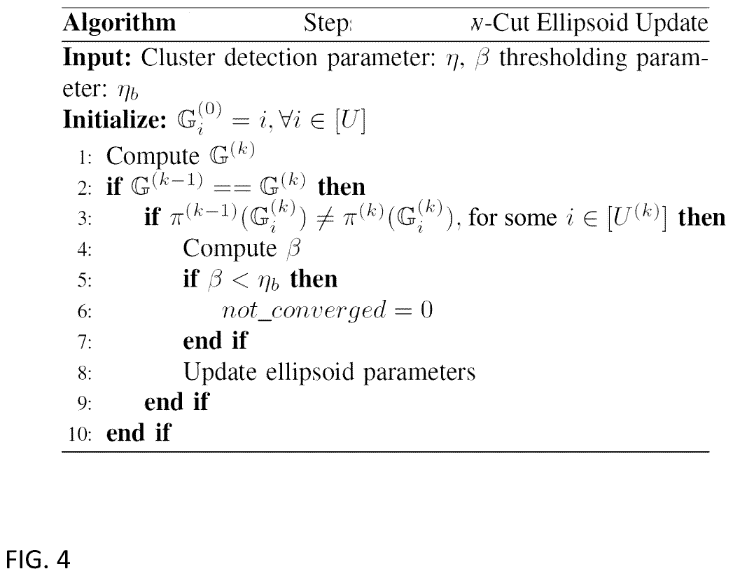

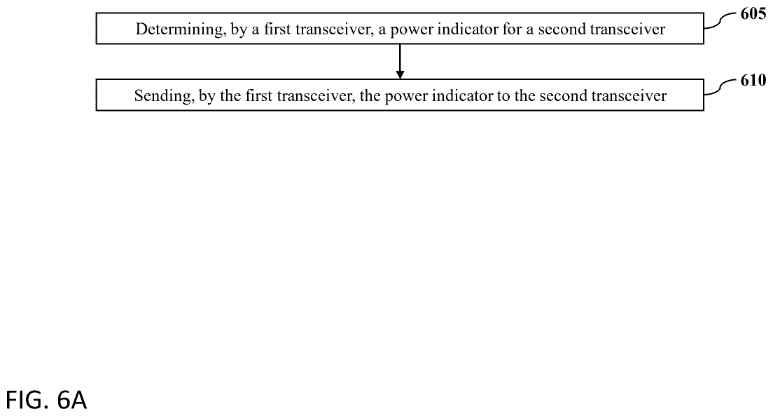

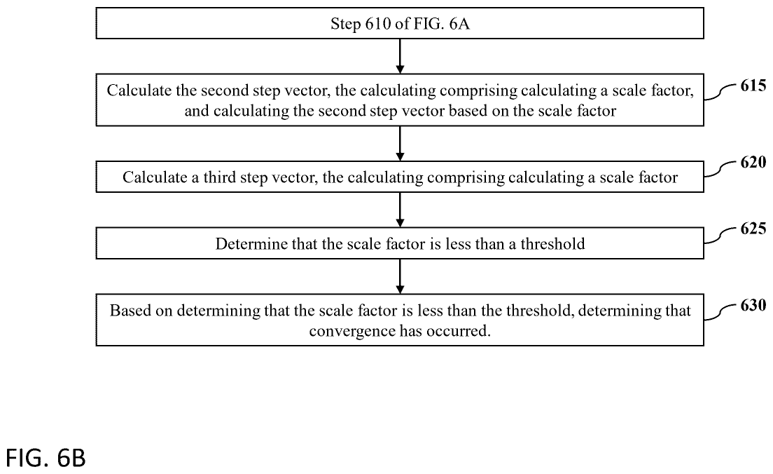

FIG. 4 shows a pseudo-code listing of (i) a method for determining whether the slowing criterion has been met (at 215), and (ii) several of the subsequent steps of the method illustrated in FIG. 2. FIGS. 6A and 6B show a method of setting transmitter power, in some embodiments. Although FIGS. 4, 6A and 6B illustrate various operations in such methods, embodiments according to the present disclosure are not limited thereto. For example, according to some embodiments, such methods may include additional operations or fewer operations, or the order of operations may vary (unless otherwise explicitly stated or implied) without departing from the spirit and scope of embodiments according to the present disclosure.

In the method of FIG. 4, each of the [symbol] is a cluster of (e.g., an ordered subset of) the indices of the elements of the vector θ. The initial values of [symbol] , which may be referred to as

$${𝔾}_{i}^{o}$$

may be set to contain only one element each, e.g., initially a respective index of each element of θ may be in a cluster by itself. During the k^{th} iteration of the second numerical optimization, which is performed at 210 (FIG. 2), the set of clusters may be computed (in step 1 of FIG. 4), by comparing adjacent elements of the sorted set of elements of the vector θ and grouping any element differing from an adjacent element by less than the first threshold in a cluster with the adjacent element (and with any other elements that may already be in the same cluster). At step 2, it may be determined whether each cluster contains the same elements as the corresponding cluster during the previous iteration (i.e., whether [symbol] == [symbol] ; if this criterion is met, then it is determined, at step 3 of FIG. 4, whether the decoding order of the elements in any cluster has changed since the previous iteration. If the criteria of both step 2 and 3 are met (e.g., if each cluster contains the same elements as during the last iteration, and if the decoding order of the element (e.g., the order of the elements when sorted by size, by applying the permutation π), has changed within at least one cluster, then the slowing criterion is met (at 215 in FIG. 2), and a reduced step size may then be used to calculate a different updated θ.

As illustrated in FIG. 6, a method for selecting a transmitter power may include determining, at 605, by a first transceiver (e.g., by an access point station 105), a power indicator (e.g., a covariance matrix) for a second transceiver; and sending, at 610, by the first transceiver, the power indicator (e.g., the covariance matrix) to the second transceiver. For example, as mentioned above, the access point station 105 may determine, for each of the concurrently transmitting non-access-point stations 110, a power indicator (e.g., a covariance matrix) specifying the transmitter power level at which the concurrently transmitting non-access-point station 110 is to operate, by minimizing the weighted sum, over all of the concurrently transmitting non-access-point stations 110, subject to the constraint that each of the concurrently transmitting non-access-point stations 110 meet a respective uplink data rate target.

The determining may include executing a second operation of a power-setting procedure (e.g., the second numerical optimization, which is performed at 210 in FIG. 2). The power-setting procedure may include, as shown in FIG. 2, a first operation (the first numerical optimization, which is performed at 205 in FIG. 2) and the second operation (e.g., the second numerical optimization, which is performed at 210 in FIG. 2). The executing of the second operation may include: determining that an updated parameter vector (e.g. θ^{k}), differing from a previous parameter vector (e.g., θ^{(k-1)}) by a first step vector (e.g., by the ordinary step vector, which may be equal to

$$\frac{1}{U + 1} {A}^{( k - 1 )} {\tilde{g}}^{( k - 1 )} ) ,$$

includes a mist element and a second element differing by less than a threshold (e.g., the first threshold; as such, the first element and the second element may be members of a cluster); and, based on determining that the updated parameter vector includes a first element and a second element differing by less than the threshold (e.g., the first threshold), adding a second step vector (e.g., the reduced step vector, which may be equal to

$$β \frac{1}{U + 1} {A}^{( k )} {\tilde{g}}^{( k + 1 )} )$$

to the previous parameter vector, the second step which may be equal to vector having a magnitude less than a magnitude of the first step vector. For example, as mentioned above in the context of FIG. 4, determining that the slowing criterion is met may include determining that the clusters are unchanged from the previous iteration ( [symbol] == [symbol] ) and that the decoding order within at least one cluster changes (π^{(k-1)}( [symbol] ≠π^{(k)} [symbol] ) if the ordinary step vector is used. As such, for the slowing criterion to be met, at least one of the clusters must include at least two elements (e.g., the updated parameter vector must include a first element and a second element differing by less than the threshold (e.g., the first threshold)). Equivalently, the slowing criterion may be met if the application of the ordinary step vector would cause the decoding order of two users to change.

In some embodiments: the second step vector is calculated, at 615, based on an ellipsoid parameter (A), and the method further includes updating the ellipsoid parameter based on determining that the updated parameter vector includes a first element and a second element differing by less than the threshold (e.g., the first threshold). For example, as mentioned above, whether the updating of the ellipsoid parameter uses the ordinary updating expression or the reduced updating expression may depend on whether the slowing criterion is met (with the reduced updating expression being used if the slowing criterion is met).

In some embodiments, the adding of the second step vector to the previous parameter vector is further based on determining that (i) in the previous parameter vector the first element is greater than the second element, and (ii) in the updated parameter vector the first element is less than the second element. For example, as mentioned above in the context of FIG. 4, for the slowing criterion to be met, at least one cluster must include at least two elements, and the decoding order must change within at least one cluster, e.g., the decoding order of the first element and the second element may be different in the previous parameter vector and in the updated parameter vector.

In some embodiments, (i) the adding of the second step vector (instead of the ordinary step vector) to the previous parameter vector is further based on determining that a first cluster of elements, within the previous parameter vector, includes the same elements as a corresponding cluster of elements in the updated parameter vector; and (ii) each of the first cluster of elements and the corresponding cluster of elements in the updated parameter vector includes a plurality of values separated by less than a threshold (e.g., the first threshold). For example, as mentioned above, each cluster may be defined as a group of elements each differing from another element in the cluster by less than the first threshold, and the slowing criterion may require that the clusters remain unchanged (e.g., the first cluster may remain unchanged) from the last iteration.

In some embodiments, the threshold (e.g., the first threshold) is less than 0.01 times a value of an element of the first cluster of elements. For example, as mentioned above, the first threshold may be 0.001 times the value of an element in the cluster. In some embodiments, (i) the adding of the second step vector to the previous parameter vector is further based on determining that each cluster of elements, within the previous parameter vector, includes the same elements as a respective corresponding cluster of elements in the updated parameter vector; each cluster of elements includes a plurality of values separated by less than a threshold; and (ii) each respective corresponding cluster of elements includes a plurality of values separated by less than a threshold (e.g., the first threshold). For example, the slowing criterion being met may require not only that one cluster (e.g., the first cluster mentioned above) remain unchanged from the previous iteration, but that all of the clusters remain unchanged.

The method may further include calculating the second step vector, the calculating including calculating a scale factor, and calculating the second step vector based on the scale factor. For example, as mentioned above, when the slowing criterion is met (and, possibly, if it is not determined that the second numerical optimization, which is performed at 210 of FIG. 2, has converged), the updated parameter vector (e.g., the updated θ) may be calculated using the reduced step vector, which may be calculated using the scale factor β.

The method may further include (i) calculating, at 620, a third step vector, the calculating including calculating a scale factor; (ii) determining, at 625, that the scale factor is less than a threshold (e.g., the second threshold); and, (iii) at 630, based on determining that the scale factor is less than the threshold, determining that convergence has occurred. For example, on a subsequent iteration of the second numerical optimization, which is performed at 210 in FIG. 2, it may be determined that the slowing criterion is met, and that the scale factor β is less than a threshold (e.g., the second threshold, e.g., a threshold of 1e-5 (e.g., a threshold of 0.00001)), which may be less than 0.0001.

In some embodiments, the use of the methods described herein may improve the technology of wireless communications by enabling rapid convergence of a method for determining transmitter power levels for each of a plurality of concurrently transmitting non-access-point stations 110. The methods disclosed herein may be performed by a processing circuit (e.g., by a processing circuit 120 of a transceiver (e.g., of an access point station 105), as shown in FIG. 1B.

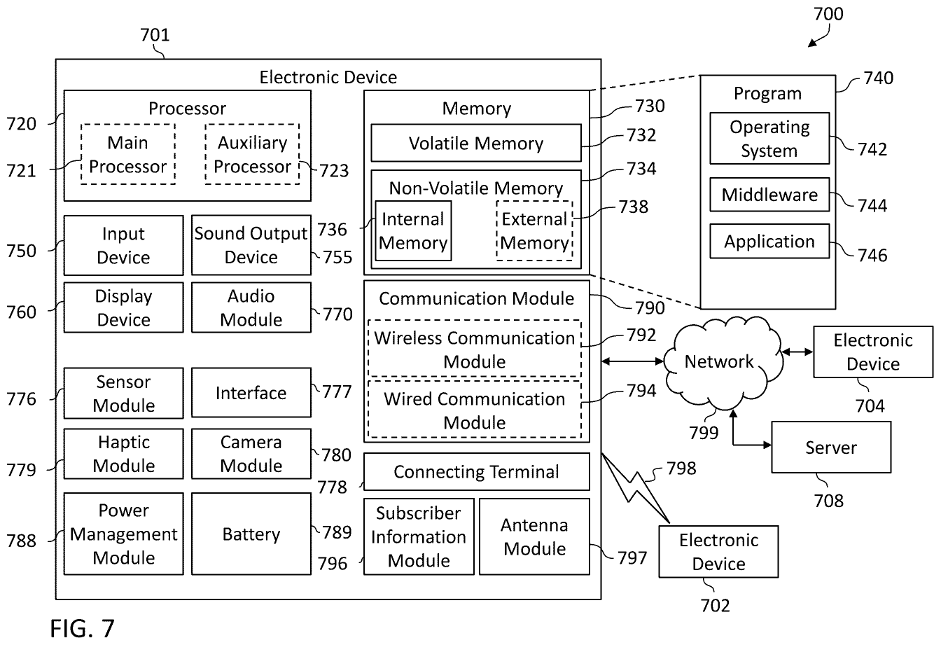

FIG. 7 is a block diagram of an electronic device in a network environment 700, according to an embodiment. The electronic device may be, for example, a mobile telephone capable of operating as a access point station 105 (which may include a processing circuit (e.g., a processor 720) for performing the methods disclosed herein), or another kind of electronic device capable of operating as a access point station 105, and it may perform one or more of the methods disclosed herein.

Referring to FIG. 7, an electronic device 701 in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 797. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations.

As at least part of the data processing or computations, the processor 720 may load a command or data received from another component (e.g., the sensor module 776 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734. Non-volatile memory 734 may include internal memory 736 and/or external memory 738.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as BLUETOOTH™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
determining, by a first transceiver, a power indicator for a second transceiver; and
sending, by the first transceiver, the power indicator to the second transceiver,
the determining comprising executing a second operation of a power-setting procedure, the power-setting procedure comprising a first operation and the second operation,
the executing of the second operation comprising:
determining that an updated parameter vector, differing from a previous parameter vector by a first step vector, includes a first element and a second element differing by less than a threshold; and
based on determining that the updated parameter vector includes a first element and a second element differing by less than the threshold, adding a second step vector to the previous parameter vector, the second step vector having a magnitude less than a magnitude of the first step vector.

2. The method of claim 1, wherein:
the second step vector is calculated based on an ellipsoid parameter, and
the method further comprises updating the ellipsoid parameter based on determining that the updated parameter vector includes a first element and a second element differing by less than the threshold.

3. The method of claim 1, wherein the adding of the second step vector to the previous parameter vector is further based on determining that:
in the previous parameter vector the first element is greater than the second element, and
in the updated parameter vector the first element is less than the second element.

4. The method of claim 1, wherein:
the adding of the second step vector to the previous parameter vector is further based on determining that a first cluster of elements, within the previous parameter vector, includes the same elements as a corresponding cluster of elements in the updated parameter vector; and
each of the first cluster of elements and the corresponding cluster of elements in the updated parameter vector includes a plurality of values separated by less than a threshold.

5. The method of claim 4, wherein the threshold is less than 0.01 times a value of an element of the first cluster of elements.

6. The method of claim 1, wherein:
the adding of the second step vector to the previous parameter vector is further based on determining that each cluster of elements, within the previous parameter vector, includes the same elements as a respective corresponding cluster of elements in the updated parameter vector;
each cluster of elements includes a plurality of values separated by less than a threshold; and
each respective corresponding cluster of elements includes a plurality of values separated by less than a threshold.

7. The method of claim 1, further comprising calculating the second step vector, the calculating comprising calculating a scale factor, and calculating the second step vector based on the scale factor.

8. The method of claim 1, further comprising:
calculating a third step vector, the calculating comprising calculating a scale factor;
determining that the scale factor is less than a threshold; and
based on determining that the scale factor is less than the threshold, determining that convergence has occurred.

9. The method of claim 8, wherein the threshold is less than 0.0001.

10. A system comprising:
a wireless transceiver, comprising
one or more processors; and
a memory storing instructions which, when executed by the one or more processors, cause performance of:
determining a power indicator for a second transceiver; and
sending the power indicator to the second transceiver,
the determining comprising executing a second operation of a power-setting procedure, the power-setting procedure comprising a first operation and the second operation,
the executing of the second operation comprising:
determining that an updated parameter vector, differing from a previous parameter vector by a first step vector, includes a first element and a second element differing by less than a threshold; and
based on determining that the updated parameter vector includes a first element and a second element differing by less than the threshold, adding a second step vector to the previous parameter vector, the second step vector having a magnitude less than a magnitude of the first step vector.

11. The system of claim 10, wherein:
the second step vector is calculated based on an ellipsoid parameter, and
the instructions, when executed by the one or more processors, further cause performance of:
updating the ellipsoid parameter based on determining that the updated parameter vector includes a first element and a second element differing by less than the threshold.

12. The system of claim 10, wherein the adding of the second step vector to the previous parameter vector is further based on determining that:
in the previous parameter vector the first element is greater than the second element, and
in the updated parameter vector the first element is less than the second element.

13. The system of claim 10, wherein:
the adding of the second step vector to the previous parameter vector is further based on determining that a first cluster of elements, within the previous parameter vector, includes the same elements as a corresponding cluster of elements in the updated parameter vector; and
each of the first cluster of elements and the corresponding cluster of elements in the updated parameter vector includes a plurality of values separated by less than a threshold.

14. The system of claim 13, wherein the threshold is less than 0.01 times a value of an element of the first cluster of elements.

15. The system of claim 10, wherein:
the adding of the second step vector to the previous parameter vector is further based on determining that each cluster of elements, within the previous parameter vector, includes the same elements as a respective corresponding cluster of elements in the updated parameter vector;
each cluster of elements includes a plurality of values separated by less than a threshold; and
each respective corresponding cluster of elements includes a plurality of values separated by less than a threshold.

16. The system of claim 10, wherein the instructions, when executed by the one or more processors, further cause performance of:
calculating the second step vector, the calculating comprising calculating a scale factor, and calculating the second step vector based on the scale factor.

17. The system of claim 10, wherein the instructions, when executed by the one or more processors, further cause performance of:
calculating a third step vector, the calculating comprising calculating a scale factor;
determining that the scale factor is less than a threshold; and
based on determining that the scale factor is less than the threshold, determining that convergence has occurred.

18. The system of claim 17, wherein the threshold is less than 0.0001.

19. A system comprising:
means for processing; and
a memory storing instructions which, when executed by the means for processing, cause performance of:
determining a power indicator for a second transceiver; and
sending the power indicator to the second transceiver,
the determining comprising executing a second operation of a power-setting procedure, the power-setting procedure comprising a first operation and the second operation,
the executing of the second operation comprising:
determining that an updated parameter vector, differing from a previous parameter vector by a first step vector, includes a first element and a second element differing by less than a threshold; and
based on determining that the updated parameter vector includes a first element and a second element differing by less than the threshold, adding a second step vector to the previous parameter vector, the second step vector having a magnitude less than a magnitude of the first step vector.

20. The system of claim 19, wherein:
the second step vector is calculated based on an ellipsoid parameter, and
the instructions, when executed by the means for processing, further cause performance of:
updating the ellipsoid parameter based on determining that the updated parameter vector includes a first element and a second element differing by less than the threshold.
